(19) United States
(12) Patent Application Publication
(10) Pub. No.: US 2006/0126120 A1
(43) Pub. Date: Jun. 15, 2006

(54) Image recording apparatus, method of generating print data for the same, and control program for implementing the method

(75) Inventors: Kazuya Imafuku, Kawasaki-shi (JP); Makoto Hibi, Kawasaki-shi (JP); Hisatsugu Naito, Yokohama-shi (JP); Tetsuya Kawanabe, Yokohama-shi (JP); Norio Shimura, Yokohama-shi (JP); Arata Miyagi, Yokohama-shi (JP)

Correspondence Address: ROSSI, KIMMS & McDOWELL LLP., P.O. BOX 826, ASHBURN, VA, 20146-0826, US

(73) Assignee: Canon Kabushiki Kaisha, Ohta-ku (JP)

(21) Appl. No.: 11/299,996

(22) Filed: Dec. 12, 2005

(30) Foreign Application Priority Data
Dec. 10, 2004 (JP) 2004-358970

(51) Int. Cl. G06K 15/00

(52) U.S. Cl. 358/1.18

(57) ABSTRACT

An image recording apparatus that is capable of realizing a favorable print layout where bottom orientations of image data are made uniform easily and at low cost. Rotation information of image data is obtained. A print layout type or pattern in accordance with the rotation information is selected. In accordance with the selected print layout type or pattern, print data for printing a print medium on which the image data is laid out is generated.

### BACKGROUND OF THE INVENTION

1. Field of the Invention

The present invention relates to an image recording apparatus that prints a print medium on which image data is laid out, a method of generating print data for the same, and a control program for implementing the method of generating print data.

2. Description of the Related Art

Conventionally, when printing image data, a layouter is used for laying out the image data on print media such as sheets. To prevent sheets from being wasted, the layouter automatically aligns a lengthwise orientation of each piece of the image data with a longitudinal direction of a rectangular region designated in advance on the print medium concerned. When it is necessary to rotate images for the orientation alignment, if a method is used that rotates the images by 90° in the same direction every time, the images will be laid out with no consideration whatsoever as to the “top-bottom orientations” of respective images, and therefore the following problems occur.

(1) When a plurality of image data are laid out on a single print medium, the top-bottom orientations of the resulting images may not be uniform from one another.

(2) When using a layout where in addition to image data, objects whose top-bottom orientations should be properly aligned are inserted, the top-bottom orientations of the objects may not match the top-bottom orientations of the image data.

Japanese Laid-Open Patent Publication (Kokai) No. H06-342463 discloses a solution to the above problem (1). When index printing is carried out for a plurality of originals read by a scanner, the size, orientation, and the like of the respective original image data input from the scanner are detected, and based on the thus detected information, the lengthwise orientations of the respective originals are determined. Then, further information is obtained that is indicative of whether each piece of original image data is vertically long (i.e., portrait) or horizontally long (i.e., landscape), the images are laid out, and the index printing is carried out.

As another solution to the problem (1), Japanese Patent Publication No. 3082982 discloses that images are printed in accordance with the orientations of images caused by a user to be displayed on a display or the like.

However, the techniques disclosed in Japanese Laid-Open Patent Publication (Kokai) No. H06-342463 and Japanese Patent Publication No. 3082982 have the following problems.

In the technique disclosed in Japanese Laid-Open Patent Publication (Kokai) No. H06-342463, the original data is read optically, and based on vertical and horizontal dimensions of the obtained image data, it is determined whether to output image data in portrait orientation or landscape orientation. However, this technique cannot be applied to a system such as a modern digital camera where images picked up with the camera held in a vertical posture are recorded as landscape images.

In the technique disclosed in Japanese Patent Publication No. 3082982, although it is certainly possible to solve the problem (1), to realize such technique, a display device for displaying the image data, a memory for storing the image data to be displayed, and the like are required, resulting in the unavoidable increased cost of providing such equipment. Also, when there is a large amount of image data to be printed, it will be necessary to display all of the image data and to have the user set the display orientation separately for the respective images, which makes the operation extremely complex.

### SUMMARY OF THE INVENTION

It is a first object of the present invention to provide an image recording apparatus and a print data generating method for the same, that are capable of realizing a favorable print layout where bottom orientations of image data are made uniform easily and at low cost, and a control program for implementing the method.

It is a second object of the present invention to provide an image recording apparatus and a print data generating method for the same, that are capable of making bottom orientations uniform in an entire layout including not only image data but also objects, and a control program for implementing the method.

To attain the above first and second objects, in a first aspect of the present invention, there is provided an image recording apparatus comprising a rotation information obtaining device that obtains rotation information of image data, a layout switching device that selects a print layout in accordance with the rotation information, and a print data generating device that generates, in accordance with the print layout selected by the layout switching device, print data for printing a print medium on which the image data is laid out.

According to the above construction, it is possible to realize a favorable print layout where orientations (for example, bottom orientations) of image data are made uniform easily and at low cost. In addition, it is possible to make uniform the bottom orientations of an entire layout including not only image data but also objects.

Preferably, the layout switching device includes at least four layout patterns for each of at least one layout type, and selects a predetermined layout pattern according to the rotation information, out of the four layout patterns.

Alternatively, the layout switching device includes two layout patterns for each of the at least one layout type, and selects one of the two layout patterns according to a result of a determination to determine whether the image data is for a landscape image or a portrait image based on a viewing bottom orientation included in the rotation information.

To attain the above first and second objects, in a second aspect of the present invention, there is provided an image recording apparatus comprising a rotation information obtaining device that obtains respective rotation information of a plurality of image data, a sorting device that sorts a print order of the plurality of image data in accordance with the respective rotation information, and a print data generating device that generates, in accordance with the print order sorted by the sorting device, print data for printing a print medium on which at least one image data out of the plurality of print data is laid out.

According to the above construction, it is possible to realize a favorable print layout where orientations (for example, bottom orientations) of image data are made uniform easily and at low cost. In addition, it is possible to make uniform the bottom orientations of an entire layout including not only image data but also objects.

Preferably, the sorting device comprises an image size obtaining device that obtains image sizes of the plurality of image data, and an image data lengthwise orientation determining device that determines whether the plurality of image data having been rotated so that bottom orientations thereof are set at a bottom edge of the print medium are each in portrait orientation or landscape orientation, based on the image sizes obtained by the image size obtaining device and the rotation information, and the sorting device sorts the print order of the plurality of image data based on a determination result obtained by the image data lengthwise orientation determining device.

More preferably, the image recording apparatus comprises a layouter that lays out the plurality of image data on at least one print medium, and the layouter lays out the plurality of image data on the at least one print medium such that image data determined to be in portrait orientation by the image data lengthwise orientation determining device and image data determined to be in landscape orientation are not laid out on a same print medium.

Even more preferably, the layouter includes a bottom orientation uniforming device that rotates the plurality of image data in accordance with the rotation information so that bottom orientations of image data laid out on a same print medium are made equal to one another.

Even more preferably, the image recording apparatus comprises a memory with a limitation of being incapable of storing an entire decoding result obtained when the plurality of image dada are decoded, and the bottom orientation uniforming device comprises a combination detecting device that detects a combination of the respective rotation information of the plurality of image data that minimizes a processing load of a process to be carried out by the bottom orientation uniforming device to obtain the image data having been rotated, and an image rotating section that rotates the plurality of image data in accordance with the combination detected by the combination detecting device.

More preferably, the layouter includes two layout patterns for each of at least one layout type, and uses one of the two layout patterns according to whether the image data to be laid out on a same page corresponding to the print medium is in landscape orientation or portrait orientation.

To attain the above first and second objects, in a third aspect of the present invention, there is provided an image recording apparatus comprising a rotation information obtaining device that obtains respective rotation information of a plurality of image data, a rotation angle determining device that determines rotation angles for the plurality of image data when the plurality of image data are laid out, in accordance with the rotation information, and a print data generating device that generates, in accordance with the rotation angles determined by the rotation angle deciding device, print data for printing a print medium on which the image data are laid out.

According to the above construction, it is possible to realize a favorable print layout where orientations (for example, bottom orientations) of image data are made uniform easily and at low cost. In addition, it is possible to make uniform the bottom orientations of an entire layout including not only image data but also objects.

Preferably, the rotation angle determining device includes a focus orientation determining device that determines which out of top, bottom, left, and right edges of the print medium is a focus orientation edge, and determines the rotation angles of the image data based on the rotation information so that the focus orientation edge determined by the focus orientation determining device matches with bottom orientations of the image data.

More preferably, the focus orientation edge is uniquely determined for a layout pattern for laying out the image data on the print medium.

More preferably, the focus orientation edge is determined such that those images are increased in number which correspond to the image data and whose lengthwise orientations determined with reference to viewing bottom orientations of the images determined from the rotation information match with lengthwise orientations of image layout frames determined according to a layout pattern for laying out the image data on the print medium.

To attain the above first and second objects, in a fourth aspect of the present invention, there is provided an image recording apparatus comprising a rotation information obtaining device that obtains rotation information of image data, a layout device that sets a layout for laying out the image data, with the layout reflecting the rotation information, and a print data generating device that generates, in accordance with the layout set by the layout device, print data for printing a print medium on which the image data is laid out.

According to the above construction, it is possible to realize a favorable print layout where orientations (for example, bottom orientations) of image data are made uniform easily and at low cost. In addition, it is possible to make uniform the bottom orientations of an entire layout including not only image data but also objects.

To attain the above first and second objects, in a fifth aspect of the present invention, there is provided a print data generating method for an image recording apparatus, comprising a rotation information obtaining step of obtaining rotation information of image data, a layout switching step of selecting a print layout in accordance with the rotation information, and a print data generating step of generating, in accordance with the print layout selected in the layout switching step, print data for printing a print medium on which the image data is laid out.

To attain the above first and second objects, in a sixth aspect of the present invention, there is provided a print data generating method for an image recording apparatus, comprising a rotation information obtaining step of obtaining respective rotation information of a plurality of image data, a sorting step of sorting a print order of the plurality of image data in accordance with the respective rotation information, and a print data generating step of generating, in accordance with the print order sorted in the sorting step, print data for printing a print medium on which at least one image data out of the plurality of print data is laid out.

To attain the above first and second objects, in a seventh aspect of the present invention, there is provided a print data generating method for an image recording apparatus, comprising a rotation information obtaining step of obtaining respective rotation information of a plurality of image data, a rotation angle determining step of determining rotation angles for the plurality of image data when the plurality of image data are laid out, in accordance with the rotation information, and a print data generating step of generating, in accordance with the rotation angles determined in the rotation angle determining step, print data for printing a print medium on which the image data are laid out.

To attain the above first and second objects, in an eighth aspect of the present invention, there is provided a print data generating method for an image recording apparatus, comprising a rotation information obtaining step of obtaining rotation information of image data, a layout step of setting a layout for laying out the image data, with the layout reflecting the rotation information, and a print data generating step of generating, in accordance with the layout set in the layout step, print data for printing a print medium on which the image data is laid out.

To attain the above first and second objects, in a ninth aspect of the present invention, there is provided a computer-readable control program for causing a computer to implement a print data generating method for an image recording apparatus, the control program comprising a rotation information obtaining module for obtaining rotation information of image data, a layout switching module for selecting a print layout in accordance with the rotation information, and a print data generating module for generating, in accordance with the print layout selected by the layout switching module, print data for printing a print medium on which the image data is laid out.

To attain the above first and second objects, in a tenth aspect of the present invention, there is provided a computer-readable control program for causing a computer to implement a print data generating method for an image recording apparatus, the control program comprising a rotation information obtaining module for obtaining respective rotation information of a plurality of image data, a sorting module for sorting a print order of the plurality of image data in accordance with the respective rotation information, and a print data generating module for generating, in accordance with the print order sorted by the sorting module, print data for printing a print medium on which at least one image data out of the plurality of print data is laid out.

To attain the above first and second objects, in an eleventh aspect of the present invention, there is provided a computer-readable control program for causing a computer to implement a print data generating method for an image recording apparatus, the control program comprising a rotation information obtaining module for obtaining respective rotation information of a plurality of image data, a rotation angle determining module for determining rotation angles for the plurality of image data when the plurality of image data are laid out, in accordance with the rotation information, and a print data generating module for generating, in accordance with the rotation angles determined by the rotation angle determining module, print data for printing a print medium on which the image data are laid out.

To attain the above first and second objects, in a twelfth aspect of the present invention, there is provided a computer-readable control program for causing a computer to implement a print data generating method for an image recording apparatus, the control program comprising a rotation information obtaining module for obtaining rotation information of image data, a layout module for setting a layout for laying out the image data, with the layout reflecting the rotation information, and a print data generating module for generating, in accordance with the layout set by the layout module, print data for printing a print medium on which the image data is laid out.

The above and other objects, features, and advantages of the invention will become more apparent from the following detailed description taken in conjunction with the accompanying drawings.

### BRIEF DESCRIPTION OF THE DRAWINGS

FIG. 1 is a block diagram schematically showing the construction of an image recording system including an image recording apparatus according to an embodiment of the present invention;

FIG. 2 is a block diagram showing the hardware construction of the image recording apparatus appearing in FIG. 1;

FIG. 3 is a block diagram showing a module construction of the image recording apparatus appearing in FIG. 1;

FIG. 4 is a flowchart showing the procedure of a process carried out by a rasterizer appearing in FIG. 3;

FIGS. 5A and 5B are diagrams useful in explaining index printing, with FIG. 5A showing a print unit in which index printing is carried out, and with FIG. 5B being a view of a print medium on which index printing has been carried out;

FIG. 6 is a view showing a print image into which a time/date character string has been inserted;

FIG. 7 is a flowchart showing in detail the procedure of a print data generating process in a step S310 in FIG. 4;

FIGS. 8A to 8C are schematic diagrams showing examples of where a plurality of image data are “borderlessly” laid out on a single print medium;

FIG. 9 is a flowchart showing in detail the procedure of another print data generating process in the step S310 in FIG. 4 carried out for the case where a plurality of image data are “borderlessly” laid out on a single print medium;

FIGS. 10A and 10B are diagrams useful in explaining the definitions of “row direction” and “column direction” used in the print data generating process shown in FIG. 9;

FIG. 11 is a flowchart showing in detail the procedure of a color-processed data generating process in a step S524 in FIG. 9;

FIGS. 12A and 12B are diagrams showing example layouts where object(s) is/are inserted;

FIG. 13 is a flowchart showing in detail the procedure of another color-processed data generating process in the step S524 in FIG. 9 for the case where objects are inserted;

FIG. 14 is a block diagram showing a module construction for realizing a layout information generating step (a step S304 in FIG. 4) for a first example of the present embodiment;

FIGS. 15A and 15B are diagrams useful in further explaining the first example;

FIG. 16 is a diagram schematically showing an example of a single print medium on which a plurality of images are laid out;

FIG. 17 is a block diagram showing a first module construction for realizing an image laying out step (a step S305 in FIG. 4) in a second example of the present embodiment;

FIGS. 18A, 18B, and 18C are diagrams useful in further explaining the second example, with FIG. 18A showing images designated for printing, with FIG. 18B showing a result of classifying into categories, and with FIG. 18C showing actual printing results;

FIG. 19 is a block diagram showing a second module construction for realizing the image laying out step (the step S305 in FIG. 4) in a third example of the present embodiment; and

FIG. 20 is a block diagram showing a third module construction for realizing the image laying out step (the step S305 in FIG. 4) in a fourth example of the present embodiment.

### DETAILED DESCRIPTION OF THE PREFERRED EMBODIMENTS

The present invention will now be described in detail below with reference to the drawings showing a preferred embodiment thereof. An image recording apparatus according to the present embodiment is applied to a directly connectable photo printer, for example.

First, the overall construction, hardware construction, and software construction of an image recording system used in the present embodiment will be described.

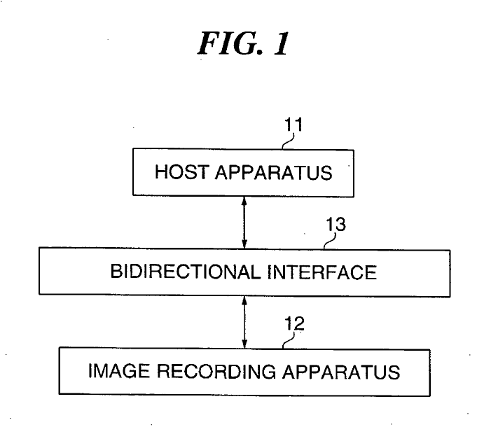

FIG. 1 is a block diagram schematically showing the construction of the image recording system including the image recording apparatus according to the present embodiment.

The image recording system shown in FIG. 1 is applied to a directly connectable photo printing system that directly prints image data supplied from a digital camera or the like and that comprises a host apparatus 11 composed of a digital camera or the like, and an image recording apparatus 12 composed of a directly connectable photo printer or the like, with both the apparatuses 11 and 12 being connected to each other via a bidirectional interface 13.

When directly printing image data from a memory card using the image recording apparatus 12, the memory card is inserted into a card adapter provided in the image recording apparatus 12 so that the image data may be accessed from the image recording apparatus 12.

Next, the hardware construction of the image recording apparatus 12 appearing in FIG. 1 will be described.

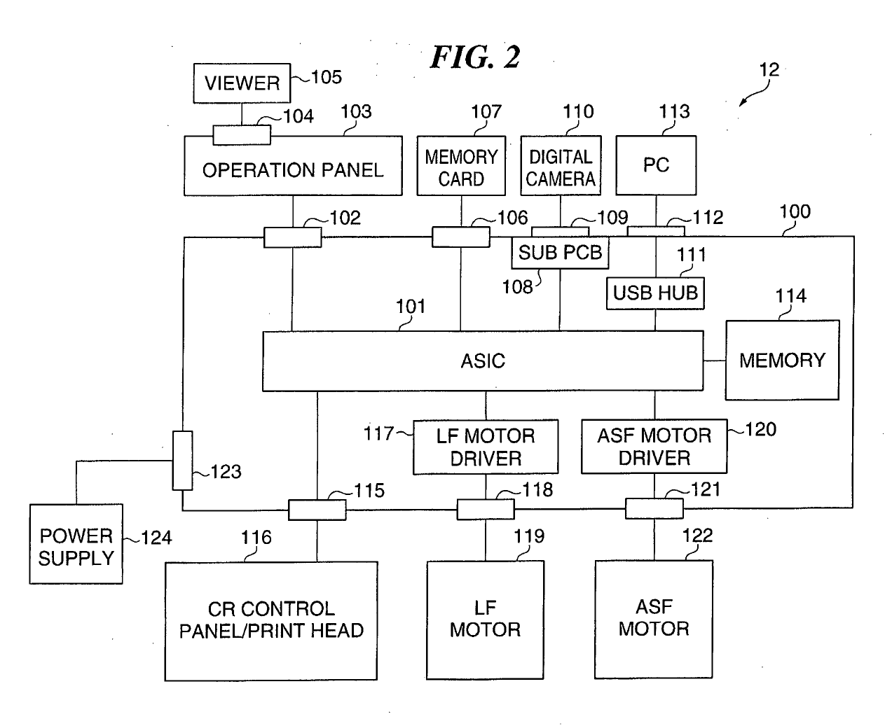

FIG. 2 is a block diagram showing the hardware construction of the image recording apparatus 12 included in the directly connectable photo printing system shown in FIG. 1.

As shown in FIG. 2, the image recording apparatus 12 includes a control board 100. The control board 100 includes an ASIC 101, which is a semiconductor integrated circuit with a CPU for carrying out image data generation and the like, and a memory 114. The memory 114 includes a program memory area that stores a control program for the CPU inside the ASIC 101, a RAM area that stores a program being executed, and a work memory area that stores image data and the like.

Reference numeral 102 in FIG. 2 denotes a connector used to connect an operation panel 103. The user uses the operation panel 103 to set various types of print setting information, and to carry out maintenance, to view images on a memory card 107, to designate print images, and to designate a start of printing, and to cancel printing. The operation panel 103 is connected via a connector 104 to a viewer 105. The viewer 105 is used to browse images recorded on the memory card 107, to display menus via a GUI, and to display various error messages.

A connector 106 is used to connect the memory card 107. Via the connector 106, the image recording apparatus 12 can directly read and print image data from the memory card 107. Reference numeral 108 denotes a USB bus connector having a port for connecting a digital camera 110 that corresponds to the host apparatus 11 appearing in FIG. 1, the USB bus connector being mounted on a sub PCB. Reference numeral 109 denotes a terminal through which the digital camera 110 is connected.

The digital camera 110 is constructed so as to be capable of storing image data and print setting information in an internal memory thereof and outputting them to the image recording apparatus 12. Note that a variety of constructions can be used for the digital camera 110, such as a construction including an internal non-removable memory or a construction including a slot for attaching a removable memory. Image data in the digital camera 110 can be processed in the image recording apparatus 12 in accordance with the print setting information set to the digital camera 110, and therefore, the image recording apparatus 12 can print images when directly connected to the digital camera 110 (a so-called “camera direct print” operation).

Reference numeral 111 denotes a USB hub that passes on image data when printing is carried out based on image data supplied from a personal computer (PC) 113 connected thereto via a connector 112. A connector 115 connects a carriage-return control panel (CR control panel) and a print head 116. The control board 100 also includes a connector 118 through which an LF motor driver 117 is connected to an LF motor 119, a connector 121 through which an ASF motor driver 120 is connected to an ASF motor 122, and a power supply connector 123 that inputs a DC voltage converted from commercial AC by a power supply 124.

Next, the software construction of the image recording apparatus 12 will be described.

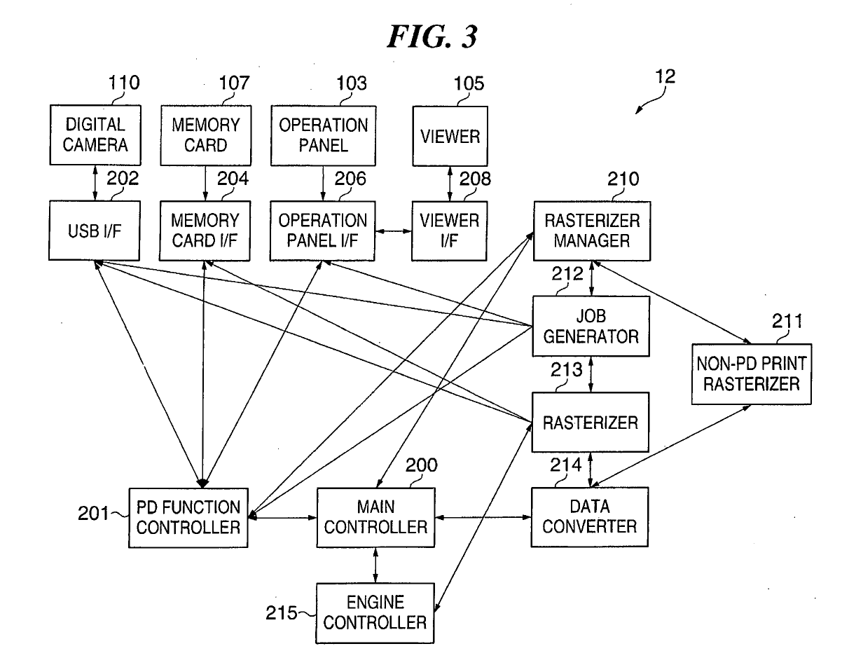

A module construction of the image recording apparatus 12 will be described with reference to FIG. 3 along the flow of processing used when direct printing is carried out from a memory card and along the flow of processing used when for direct printing is carried out from a digital camera. FIG. 3 is a block diagram showing the module construction of the image recording apparatus 12 appearing in FIG. 1.

First, explanations on direct printing using the memory card will be given.

When the memory card 107 is connected to the connector 106 of the image recording apparatus 12, the user can designate images and can give an instruction for a start of printing using the operation panel 103 and the viewer 105. By doing so, it is possible to browse and/or print images in the memory card 107.

When the user prints image data in the memory card 107, in timing in which a print start key on the operation panel 103 is pressed, first a print start request is sent from an operation panel I/F section 206 to a photo direct function (hereinafter “PD function”) control section 201. Note that the operation panel I/F section 206 and a viewer I/F section 208 cooperate to share key operation information for the operation panel 103 and connection state information for the digital camera 110 and the memory card 107, and cause the viewer 105 to display suitable menu images and image data thereon.

In response to the print start request, the PD function control section 201 informs a main control section 200 of receiving the request, and then the main control section 200 gives instructions to a digital camera USB I/F section 202 and a PC USB I/F section (not shown) to prevent them from receiving any data sent from the digital camera 110 and the PC 113. After such instructions are communicated to the digital camera 110 and the PC 113, and thereby the image recording apparatus 12 has entered a state where the image recording apparatus 12 can print from the memory card 107 exclusively, the main control section 200 gives the PD function control section 201 permission to switch to a photo direct print process.

After receiving the permission, the PD function control section 201 gives a print instruction to a rasterizer manager 210. The rasterizer manager 210 selects a rasterizer suitable for a present print mode and causes the selected rasterizer to carry out processing. For example, when printing from the PC 113, print data that is sent to the image recording apparatus 12 (the directly connectable photo printer), but when printing directly from the digital camera 110 or the memory card 107, not print data but image file data that has not been decoded nor otherwise processed is sent to the image recording apparatus 12. For this reason, when printing from the PC 113, the rasterizer manager 210 selects a non-PD print rasterizer 211 and causes the non-PD print rasterizer 211 to process the print data from the PC 113, while when printing from the digital camera 110 or the memory card 107, the rasterizer manager 210 causes a job generating section 212 and a rasterizer 213 to operate and thereby generate the print data.

When receiving a print processing instruction from the rasterizer manager 210, the job generating section 212 first enquires to the PD function control section 201 as to whether direct printing to be carried out at present is from the memory card 107 or from the digital camera 110. When, as a result, the job generating section 212 is notified that the direct printing from the memory card 107 is to be carried out, the job generating section 212 obtains the print setting information set by the user from the operation panel I/F section 206 and generates a job. After this, the job generating section 212 gives a print processing instruction to the rasterizer 213.

The rasterizer 213 generates print data based on job information on the generated job. The job information is composed of information on a size (sheet size) and type (sheet type) of print medium, a printing method such as single image layout printing or index printing, print quality, instructions relating to various types of image correction, information relating to the image file(s) designated for printing, and information indicating from which of the memory card 107 and the digital camera 110 the printing is to be carried out.

The rasterizer 213 first interprets the job information, determines an operation mode of a printer engine section (not shown) based on the type of medium and the print quality, and informs an engine control section 215 of the determined operation mode. Next, layout information indicative of the positions and sizes to be used when laying out image data on a single print medium is generated in accordance with the sheet size and printing method, and print data is then generated using information relating to the image file(s) designated for printing. The print data is generated by the following steps, for example.

(1) Read and decode the image file(s) designated for printing.

(2) Convert a color space of the decoded image data to a color space unique to a corresponding device.

(3) Carry out halftoning in which respective pixels are quantified into quantized amounts indicative of states of the respective pixels.

Note that the quantification is carried out according to a data format which can be processed by the image recording apparatus 12. For example, when the image recording apparatus 12 records images based on binary data, respective pixels are binarized, while when the image recording apparatus 12 records images based on multivalic data (to record images using ink capable of reproducing a plurality of tones according to print density or to record images using ink capable of reproducing a plurality of tones according to dot size), respective pixels are multivalued.

In addition, the rasterizer 213 outputs requests for sheet feeding or sheet discharging, sheet conveying, printing, and the like to the engine control section 215 as necessary, and exchanges messages with the engine control section 215 so that the processing proceeds in synchronization.

In the case of direct printing from the memory card 107, access-to the image file(s) designated for printing is carried out via a memory card I/F section 204. On the other hand, when printing is carried out from the digital camera 110, access is carried out via the USB I/F section 202.

A data converting section 214 converts print data generated by the rasterizer 213 and print data received from the non-PD print rasterizer 211 to a data format that can be received by the printer engine section, and notifies the engine control section 215 of converted data via the main control section 200 whenever a predetermined amount of converted data has accumulated.

The engine control section 215 transfers the converted data to the printer engine section, while taking account the operation mode of the printer engine, and causes the printer engine to carry out a print process.

Next, processing when printing directly from the digital camera 110 will be described.

When the digital camera 110 is connected to the terminal 109 (the USB I/F section 202), the user can use a function provided in the digital camera 110 to designate images, to make print settings, and to give an instruction for start of printing. By doing so, it is possible to browse and/or print images stored in the memory (storage section) of the digital camera 110. When image data is directly printed from the digital camera 110, in timing in which a print start key of the digital camera 110 is pressed, first a print start request is sent from the USB I/F section 202 to the PD function control section 201.

In response to the print start request, the PD function control section 201 informs the main control section 200 of receiving the request, and then the main control section 200 gives instructions to the memory card I/F section 204 and the PC USB I/F section to prevent them from receiving any data sent from the memory card 107 and the PC 113. After such instructions are communicated to the memory card 107 and the PC 113 and thereby the image recording apparatus 12 has entered a state where the image recording apparatus 12 can print from the digital camera 110 exclusively, the main control section 200 gives the PD function control section 201 permission to switch to a photo direct print process.

The operation of the PD function control section 201 in this case is the same as with the case where direct printing from the memory card 107 is carried out.

In response to the print processing instruction from the rasterizer manager 210, the job generating section 212 first enquires to the PD function control section 201 as to whether direct printing to be carried out at present is from the memory card 107 or from the digital camera 110. When, as a result, the job generating section 212 is notified that the direct printing from the digital camera 110 is to be carried out, the job generating section 212 obtains the print setting information set by the user from the USB I/F section 202 and generates a job. After this, the job generating section 212 gives a print processing instruction to the rasterizer 213.

The operation of the rasterizer 213 in this case is substantially the same as when direct printing is carried out from the memory card 107, with the difference being that the desired image file(s) is/are accessed via the USB I/F section 202. The data converting section 214 and the engine control section 215 carry out the same operation as in the direct printing from the memory card 107.

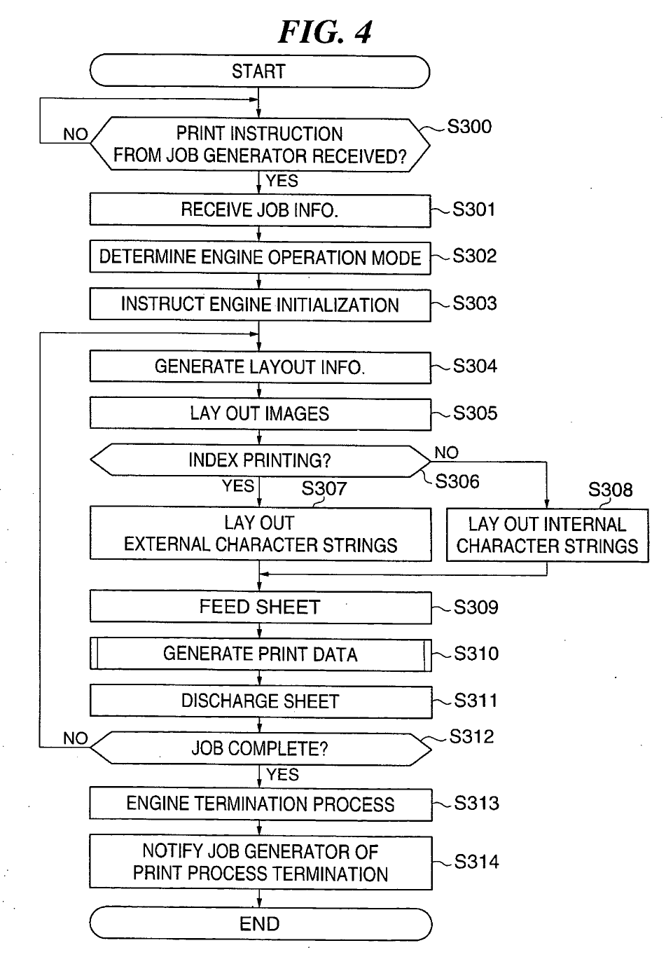

The present invention is most closely related to the rasterizer 213 in the module construction described above, and the process carried out by the rasterizer 213 will now be described with reference to FIGS. 4, 5A, 5B, and 6.

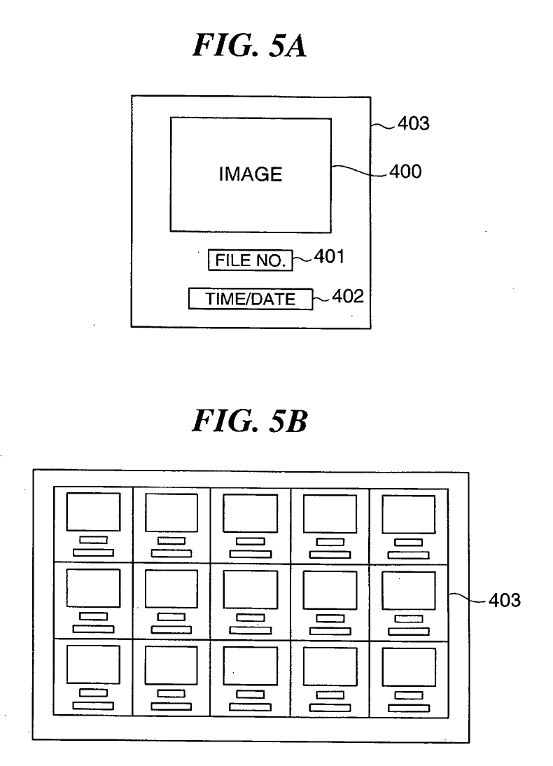

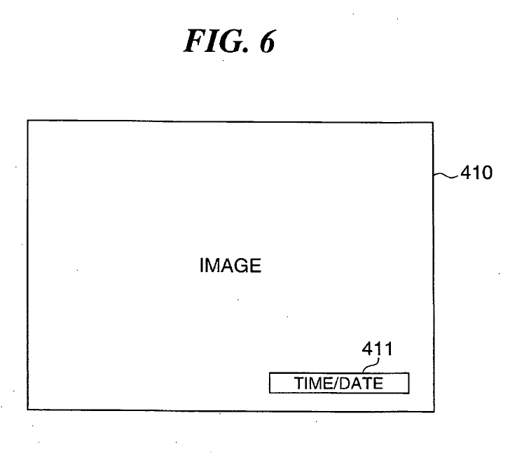

FIG. 4 is a flowchart showing the procedure of a process carried out by the rasterizer 213 appearing in FIG. 3. FIGS. 5A and 5B are diagrams useful in explaining index printing, with FIG. 5A showing a print unit for carrying out index printing, and with FIG. 5B being a view of a print medium on which index printing has been carried out. FIG. 6 is a view showing a print image into which a time/date character string has been inserted.

As shown in FIG. 4, first, when a print instruction is received from the job generating section 212 as a job generating module (“YES” to a step S300), a print data generating process starts, and then in a step S301, job information designated by the user is received, which is composed of a variety of information on such as sheet size, sheet type, print method, print quality, image correction settings, and print designated image(s).

In a step S302, by referring to the information about the sheet type, the print quality, whether printing with margins is to be carried out, and the like that is included in the job information obtained in the step S301, the operation mode of the printer engine section is determined. In a step S303, the engine control section 215 is notified of the operation mode of the printer engine section determined in the step S302, and then the printer engine section to carry out printing is instructed to initialize itself.

Next, in a step S304, by referring to the sheet size, the print method, and the like in the job information, with consideration to resolution information for print data that varies according to the operation mode of the printer engine section determined previously, the layout information about how many images are to be laid out on a single print medium and the positions and sizes of the respective images is generated. Also, in the step S304, internal character string layout information indicative of an insertion position of a character string into a corresponding image used when carrying out date/time printing and external character string layout information indicative of a layout position of a character string on a margin area around a corresponding image used when carrying out index printing are set (generated) in the same way. Settings are also made for various types of objects aside from image data and character strings, such as ruled lines.

After this, an image laying out step (step S305) is carried out at a start of each page. In this step, it is determined which image data out of the image data designated for printing are to be laid out at respective image layout positions set for the page in the step S304. Next, in a step S306, by referring to the job information, it is determined whether the presently requested job is index printing or another type of printing and then a step to be executed next is switched accordingly.

When index printing is determined in the step S306, the process proceeds to an external character string laying out step (step S307). Here, processing is carried out in accordance with the external character string layout information set earlier in the step S304. In the case of index printing, a list of a plurality of image data on the memory card 107 is printed, and as shown in FIG. 5A, time/date character strings 402 indicative of the time/date when the data of respective images 400 were created, and file numbers 401 are also printed.

Index printing is used to generate an image list 403 as shown in FIG. 5B. For example, each image 400 is combined with the corresponding time/date character string 402 and the corresponding file number 401 so as to form a single printing unit as shown in FIG. 5A, and a plurality of such printing units are arranged and printed, as shown in FIG. 5B. To do so, in a step S307, information (external character strings) such as the creation time/dates and file numbers for the respective image data laid out on the print medium in the step S305 is obtained, and based on the external character string layout information set in the step S304, the external character strings are disposed at layout positions that satisfy certain positional relationships such as those shown in FIG. 5A with the image layout positions for the corresponding image data. By doing so, settings as to which character strings should be printed at such layout positions are made.

On the other hand, when it is determined in the step S306 that the job to be executed is not index printing, the process proceeds to an internal character string laying out step (step S308). In this step, first, by referring to the job information, it is determined whether the user has designated time/date printing. If time/date printing is not to be carried out, no processing is carried out in the step S308 and the process proceeds to the next step. Conversely, if time/date printing is to be carried out, processing is carried out in accordance with the internal character string layout information set in the step S304.

When time/date printing is carried out without carrying out index printing, as shown in FIG. 6, a time/date character string 411 is inserted into image data 410 and printed. Layout position information for such character string represents the internal character string layout information. In the step S308, settings are made to dispose a file creation time/date obtained from the corresponding image data at the layout position.

When layout settings for images and the like have been made, the process proceeds to a step S309. In the step S309, the rasterizer 213 instructs the engine control section 215 to carry out sheet feeding. After this, a print data generating process (step S310) and a sheet discharging process (step S311) are carried out. In the step S312, it is determined whether the job has been completed. When the job has not been completed, the process returns to the step S304, while when the job has been completed, a termination process for the printer engine section is carried out (step S313), and the job generating section 212 is notified of the termination of the print process (step S314).

Next, a first case where one image data is printed on one print medium will be described.

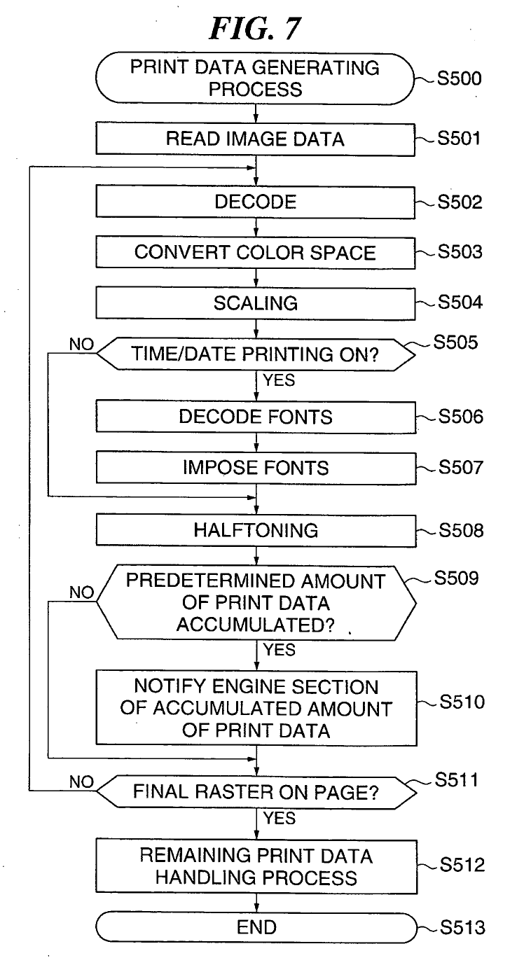

FIG. 7 is a flowchart showing in detail the procedure of the print data generating process (the step S310) in FIG. 4, and for convenience shows how one image data is laid out and printed on one print medium.

The image recording apparatus 12 starts the print data generating process (step S500), and first in a step S501 reads the image data designated for printing from the digital camera 110 or the memory card 107 and stores the image data in the memory 114.

Although it is preferable that there is enough space in the memory 114 for all of the image data to be written therein in a single operation, when this is not possible, the image data may be decoded in part in a decoding operation carried out in a step S502 and enough data for decoding one part may be written into the memory 114 whenever necessary. For ease of explanation, the case where all of the image data is written into the memory 114 in a single operation will be described here.

Next, in the step S502, the image data written in the step S501 is referred to and decoded. Here, image data in one of a variety of formats, such as JPEG or TIFF, is decoded. When there is space in the memory 114, an entire image is decoded and the resulting decoded image data is stored in the memory 114 before the process proceeds further. Conversely, when there is insufficient space in the memory 114, decoding is carried out for a basic unit of image data for the subsequent processing, for example, one raster unit for the case where the orientation of the image data has been aligned with an actual layout orientation on the print medium. Here, when the image to be decoded has a JPEG format, for convenience the image may be decoded in units of eight or sixteen rasters corresponding to the size of the MCU (minimum coded unit).

In the following, the description will be given for only the realistic case where there is insufficient space in the memory 114 of the image recording apparatus 12 of the present embodiment, that is, where the image data generating process is carried out after the image data has been decoded in units of a single raster or eight/sixteen rasters.

In a step S503, a color space of the decoded image data obtained in the step S502 is converted to a color space that is unique to a corresponding device. This conversion may be carried out by direct calculation using a formula or by using an LUT (look-up table).

Next, in a step S504, the image data of which the color space has been converted in the step S503 is subjected to a scaling process in accordance with a size designated as the layout information, that is, the size of a rectangle into which the image data is to be actually laid out on the print medium. Here, a variety of algorithms may be used for the scaling process, such as a nearest neighbor, bilinear, or bicubic algorithm. The layout information is then referred to and the data that has been subjected to the scaling process is outputted to a position corresponding to the image layout position in a line buffer whose capacity corresponds to the width of the print region.

After this, in a step S505, it is determined whether time/date printing is on or off, and when time/date printing is on, steps S506 and S507 are carried out. When time/date printing is off, such steps are not carried out.

In the step S506, the character strings to be decoded and output sizes thereof are determined in accordance with the character string information set in the step S308 in FIG. 4, font data corresponding to the character strings is decoded and subjected to a scaling process to sizes corresponding to the output sizes to thereby create bitmap data, and the process then proceeds to the step S507. In the step S507, the created bitmap data is referred to and in accordance with the character string information designated in the step S308 in FIG. 4, fonts corresponding to the bitmap data are imposed on a suitable position in the image data produced by the scaling process in the step S504. After this, in a step S508, halftoning is carried out for the image data for which the scaling process has been made in the step S504 or the image data on which the fonts have been imposed in the step S507.

Next, in a step S509, it is determined whether or not a predetermined amount of print data required when the printer engine section carries out printing, that is, a basic processing unit amount of print data, has accumulated. When such data amount has been accumulated, the process proceeds to a step S510. While when such data amount has not been accumulated, the step S510 is skipped and the process instead proceeds to a step S511. The basic processing unit varies depending on the printer engine section, and can be set to correspond to sixteen rasters, for example. In the step S510, the printer engine section is notified about an accumulated amount of print data, and in response to the notification, the printer engine section starts processing the print data accumulated by the rasterizer.

In the step S511, based on a number of rasters in the page that have been processed and the layout information set in the step S304 in FIG. 4, it is determined whether a final raster in the page has been reached. When the final raster has not been reached, the process returns to the step S502 and the process is repeated from the decode step onwards. Conversely, when the processing of the page has been completed, the process proceeds to a step S512.

In the step S512, remaining print data handling process is carried out for the case where the step S511 notifies that there is remaining print data that is less in amount than the basic processing unit and has not been subjected to print processing by the printer engine section. For example, when the basic processing unit for the printer engine section is set to correspond to sixteen rasters and only print data corresponding in amount to eight rasters has been accumulated, the deficient part corresponding in amount to eight rasters is filled with null data, that is, data for which no ink is printed. The resultant print data whose amount corresponds to the basic processing unit is then notified to the printer engine section. After this, the print data generating process is terminated (step S513).

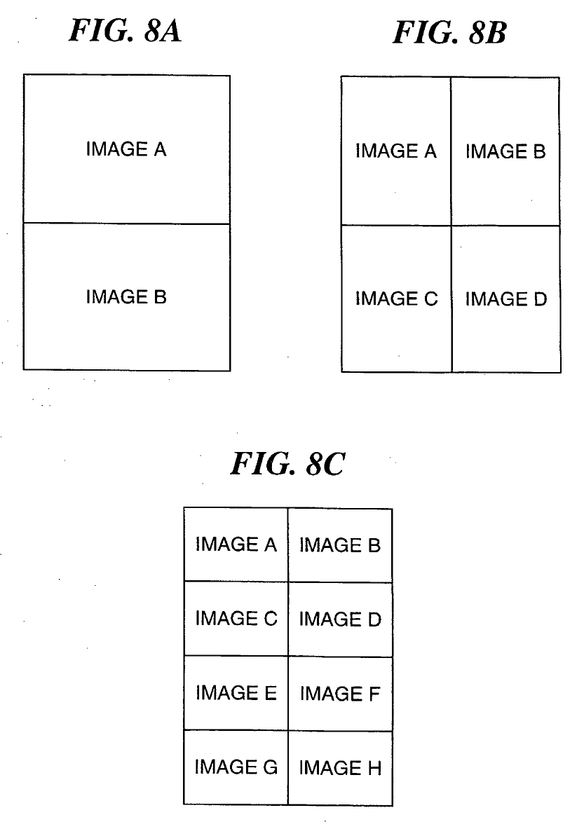

In the first case described above, an example of the print data generating process (the step S310 in FIG. 4) is described, wherein one image data is laid out and printed on one print medium. Next, a second case will be described where a plurality of image data are laid out and printed on one print medium by the print data generating process (the step S310 in FIG. 4). There are a variety of ways for laying out a plurality of image data, but here as shown in FIGS. 8A to 8C, the case where a plurality of images are borderlessly disposed on one print medium in a regular pattern will be described.

FIGS. 8A to 8C are schematic diagrams showing examples of where a plurality of image data are “borderlessly” laid out on one print medium. In these examples, eight image data labeled image data A to H are laid out two on each of four print media (FIG. 8A), four on each of two print media (FIG. 8B), and all eight on a single print medium (FIG. 8C). It should be obvious however that various layouts can be realized by arranging images in a regular pattern.

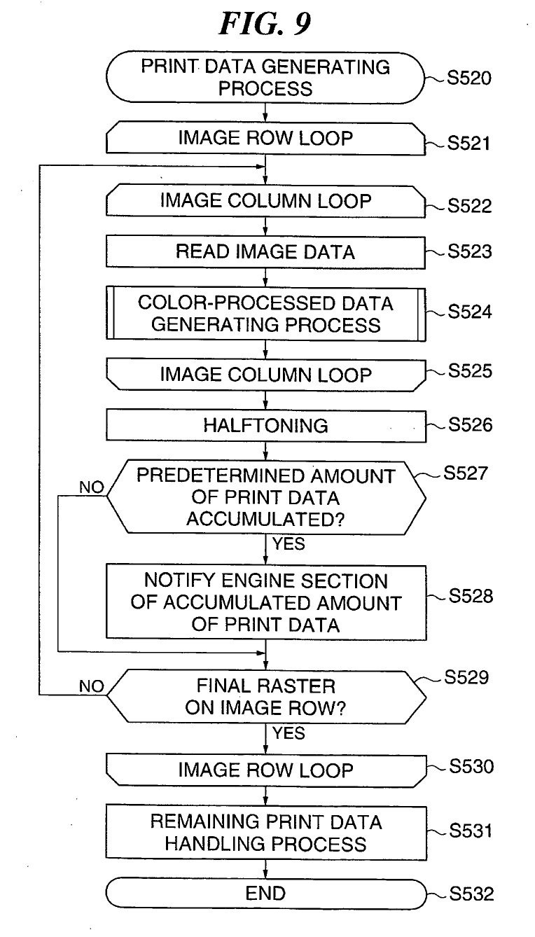

FIG. 9 is a flowchart showing in detail the procedure of print data generating process that may be carried out in the step S310 in FIG. 4 for the case where a plurality of image data are “borderlessly” laid out on a single print medium. In this process, image data is laid out using any one of the layouts shown in FIGS. 8A to 8C to generate print data.

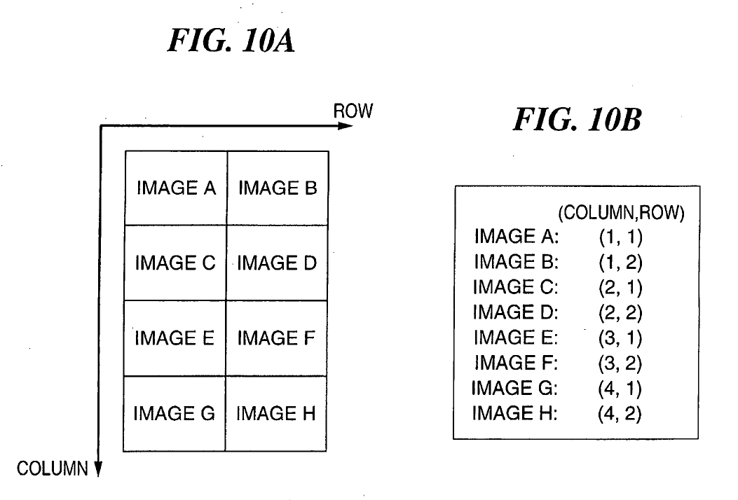

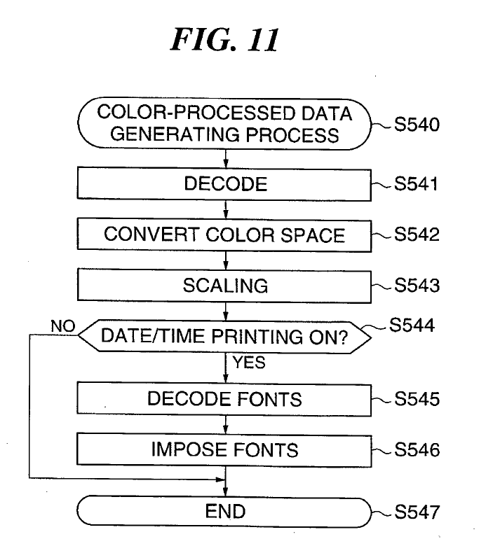

The print data generating method when a plurality of images are laid out according to the present embodiment will now be described with reference to FIGS. 9, 10A, 10B, and 11. FIGS. 10A and 10B are diagrams useful in explaining the definitions of “row direction” and “column direction” used in the print data generating process shown in FIG. 9. FIG. 11 is a flowchart showing in detail the procedure of a color-processed data generating process (step S524) shown in FIG. 9.

In the present embodiment, for convenience, when laying out a plurality of images, the row direction and column direction are defined as shown in FIG. 10A, and using such definitions, the positions of respective images are each expressed by an image row and an image column as shown in FIG. 10B. When the print data generating process for laying out a plurality of images starts (step S520 in FIG. 9), an image row loop from a step S521 to a step S530 is executed.

In the process shown in FIG. 9, the print data generating process is repeated for each of the image rows shown in FIGS. 10A and 10B. More specifically, first print data for the first row is generated, and then the process is repeated for each of the second, third, . . . , and n^{th} rows. The image row loop is represented by the steps S521 to S530 in FIG. 9. In the example in FIGS. 10A and 10B, image data is generated for image A and image B first, and when the processing is complete, image data is next generated for image C and image D. After this, image data is generated for image E and image F, and finally for image G and image H.

When the generation of one page of print data has been completed, a remaining print data handling process is carried out in a step S531, and the print data generating process is completed in a step S532. Here, the remaining print data handling process in the step S331 has the same role as the step S512 in FIG. 7 described earlier.

Next, the image row loop will be described in detail. In the process shown in FIG. 9, print data is generated in units of one raster as in the process shown in FIG. 7 described earlier. In this process, an image data reading step (step S523) and a color-processed data generating step (step S524) are each carried out in image units. The processing in each of the steps S523 and S524 does not need to be carried out in any particular order with regard to respective images included in the same image row. In FIG. 9, an image column loop (repeated between steps S522 and S525) that carries out processing in order of image column is given by way of example. In the example shown in FIGS. 10A and 10B, when one row of print data is generated, the processing in each of steps S523 and S524 is carried out in the order from image A to image B. Since the output obtained by one iteration of the processing is only one raster, in reality the processing is repeated until the final raster in one image row is reached.

The image data reading step in the step S523 is carried out in the same way as in the step S501 in FIG. 7. The details of the color-processed data generating process in the step S524 are shown in FIG. 11.

In FIG. 11, steps S540 and S547 are respectively the start and the end of the color-processed data generating process. The decode process in a step S541 and a color space converting process in a step S542 are respectively the same as the steps S502 and S503 in FIG. 7, and are followed by an image data scaling process in a step S543 that is the same as the step S504 in FIG. 7. In the same way, a date/time printing on/off determining process in a step S544, a font decoding process in a step S545, and a font imposing process in a step S546 are respectively the same as the steps S505, S506, and S507 in FIG. 7.

Referring to FIG. 9 again, in a step S526, the color-processed output data for one raster obtained in the step S525 as the output of the image column loop is subjected to halftoning. When a predetermined amount of print data corresponding to the basic processing unit has accumulated in a step S527, the printer engine section is notified in a step S528 that the predetermined amount of print data has accumulated. The halftoning process in the step S526, the print data accumulated amount confirming process in the step S527, and the process of notifying the printer engine section about the print data accumulated amount in the step S528 have respectively the same roles as the steps S508, S509, and S510 in FIG. 7.

Next, in a step S529, it is determined whether the raster presently being processed is the final raster on the image row presently being processed. When this is the case, the process proceeds to a step S530 to advance the process to the next image row, while when this is not the case, the process returns to the image column loop of the step S522 to process the next raster in the image row being processed.

Next, when the image row loop is completed, a remaining print data handling process is carried out in a step S531, and the print data generating process is terminated in a step S532. In the step S531, in respect of each of images A-H, remaining print data less in amount than the basic processing unit and not having been subjected to print processing is subjected to remaining print data handling process as in the step S512 in FIG. 7.

It should be noted that each image row (corresponding two images among images A-H) may be subjected to the remaining print data handling process immediately after the final raster in the image row has been detected in the step S529 in FIG. 9, and then the image row loop concerned therewith may be terminated in the step S530.

In the second case described above, an example of the processing in the image data generating process (the step S310) has been explained, where a plurality of image data are laid out and printed on a single print medium. Next, a third case for the print data generating process (the step S310) will be described, where at least one image data is laid out on one print medium and printed with an object such as ruled lines being inserted.

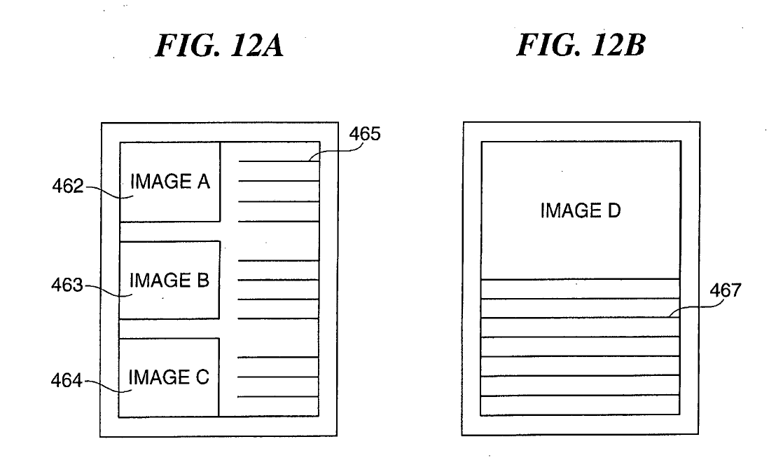

Although a variety of layouts can be used, layouts such as those shown in FIGS. 12A and 12B will be described here. FIGS. 12A and 12B are diagrams showing example layouts where object(s) is/are inserted. FIG. 12A shows an example where three image data A, B, and C and ruled lines 465 are laid out on a single print medium, and FIG. 12B shows an example where one image data D and ruled lines 467 are laid out on a single print medium, but it should be obvious that a variety of other layouts are possible.

A process for laying out image data with the layouts shown in FIGS. 12A and 12B and generating print data will now be described. This process is substantially the same as the process (FIG. 9) used when laying out a plurality of image data described earlier, with only the color-processed data generating process (the step S524) differing.

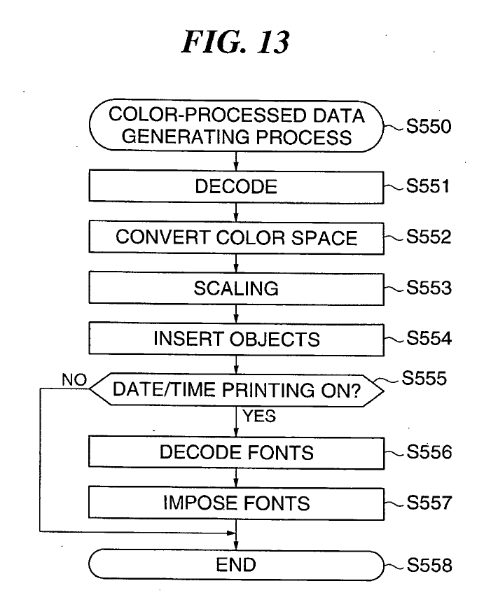

FIG. 13 is a flowchart showing in detail the color-processed data generating process carried out in the step S524 for the case where objects are inserted. The color-processed data generating process for the case where at least one image data and objects such as ruled lines are laid out will now be described with reference to FIG. 13.

In FIG. 13, steps S550 and S558 are respectively the start and the end of the color-processed data generating process. A decode process in a step S551 and a color space converting process in a step S552 are respectively the same as the steps S502 and S503 in FIG. 7, and an image data scaling process in a step S553 is the same as the step S504 in FIG. 7.

After the image data has been scaled in the step S553, the process proceeds to an object inserting process in a step S554. Here, objects are inserted in accordance with object information designated in the layout information generating step (the step S304) in FIG. 4. At this stage, since the color space of the image data has already been converted to the color space unique to the device, data for the latter color space is used when objects such as ruled lines are inserted.

In the layouts in FIGS. 12A and 12B, the ruled lines 465 and 467 of a single color are inserted, and thus it will be possible to insert objects without carrying out a color space converting process, if the color of the ruled lines to be inserted in the color space unique to the device is stored for each type of print medium, and therefore a favorable throughput can be achieved. If an object such as a bitmap image whose color is not a single color is inserted, it will be necessary to insert the object before the color space conversion. There are several reasons for this. First, on one hand, it is typically necessary to enlarge or reduce the objects to be inserted such as ruled lines in accordance with the layout. On the other hand, when the color of the object is not a single color, a variety of colors will be generated after the object being subjected to the enlarging/reducing processing, depending on the method used therefor, and hence a large-capacity memory would be required to store device-unique colors corresponding to the respective colors. Such must be avoided. Secondly, when the object to be inserted is a bitmap image, a reduction in the processing load can be achieved by carrying out the scaling process for the object together with the scaling process for the image data.

Also, a date/time printing on/off determining process in a step S555, a font decoding process in a step S556, and a font imposing process in a step S557 are respectively the same as the steps S505, S506, and S507 in FIG. 7.

This completes the description of the processing of the rasterizer 213.

First to fourth examples according to the embodiment described above will now be described.

The first example relates to the layout information generating step (the step S304) in FIG. 4 described above, with image data being laid out as shown in FIG. 12B. In the first example, to favorably lay out image data in accordance with the layout shown in FIG. 12B, the following construction and procedures are used.

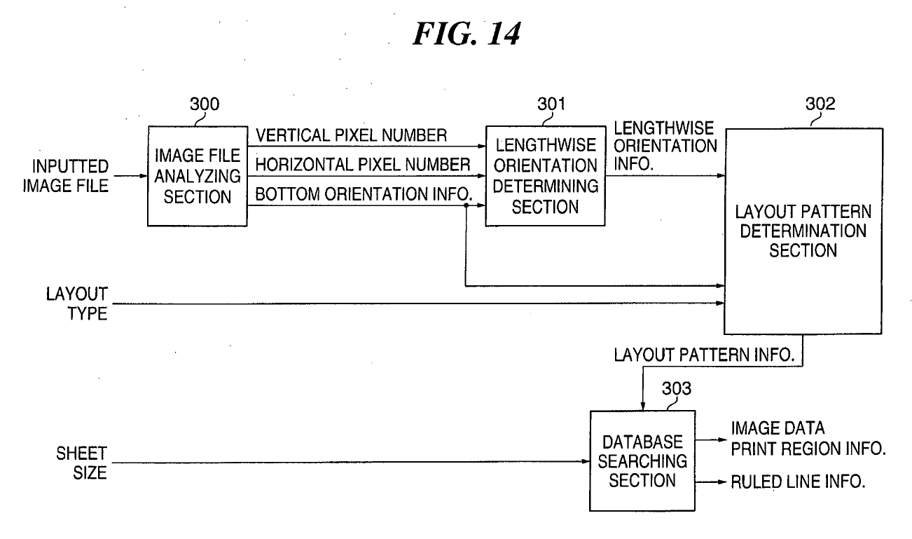

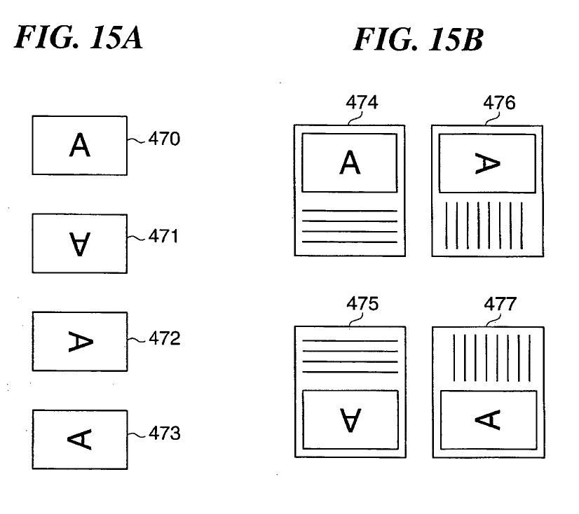

FIG. 14 is a block diagram showing a module construction for realizing the layout information generating process (the step S304) for the first example, and FIGS. 15A and 15B are diagrams useful in further explaining the first example. In the first example, layout information is generated by procedures (A1) to (A4) described below.

In the procedure (A1), an image data file to be laid out on the page concerned is analyzed to thereby obtain an image size (vertical pixel number and horizontal pixel number) and viewing (or image pickup) bottom orientation information as rotation information. In FIG. 14, an image file analyzing section 300 obtains the viewing bottom orientation information from an inputted image file as described below. In recent years, a digital camera or the like with a gravity sensor is designed to store image files in each of which bottom orientation information is written that is indicative of which of a top, bottom, left, and right of the image file corresponds to the bottom of an associated image observed at the time of viewing (picking up) the image. Since this bottom orientation information is marked by tags so that the information can be easily distinguished from other image pickup information contained in an image file, the information can be obtained by analyzing the tags. The image size can be obtained by interpreting a header of the image file. Although the example of information indicative of the bottom orientation is described in the first example, it should be obvious that any information that is useful for viewing images the right way up may be used, such as information indicative of an image top, bottom, left, or right side.

In the procedure (A2), a layout pattern used to actually lay out an image is determined from lengthwise orientation and viewing image bottom information of the image. This processing is performed by a lengthwise orientation determining section 301 and a layout pattern determining section 302 in FIG. 14. First, the lengthwise orientation can be easily determined by comparing the number of vertical pixels and the number of horizontal pixels of the image obtained in the procedure (A1) described above. That is, when the number of vertical pixels is larger than that of the horizontal pixels, an up-down direction of the image is the lengthwise orientation, and in the opposite case, a width direction of the image is the lengthwise orientation. This determination is carried out by the lengthwise orientation determining section 301 that outputs information indicative of a determination result.

As shown by image data 470, 471, 472, and 473 in FIGS. 15A, images actually picked up by the digital camera 110 or the like are classified into four patterns based on the lengthwise orientation obtained as described above and the viewing bottom orientation information obtained in the procedure (A1) described above. That is, there are four patterns, i.e., the case where an image is a landscape image and a bottom of the image is the viewing bottom orientation (as shown by the image data 470), the case where an image is a landscape image and a top of the image is the viewing bottom orientation (as shown by the image data 471), the case where an image is a portrait image and a left edge of the image is the viewing bottom orientation (as shown by the image data 472), and the case where an image is a portrait image and a right edge of the image is the viewing bottom orientation (as shown by the image data 473).

If such image data is laid out using the layout shown in FIG. 12B without considering the orientation thereof, although the image data 470 can be laid out favorably, other images will be laid out inappropriately.

For this reason, in the first example, four layout patterns 474, 475, 476, and 477 shown in FIG. 15B are provided for the layout type shown in FIG. 12B, and one out of such layout patterns is selected for use according to the pattern of the inputted image data. This selection process is carried out by the layout pattern determining section 302. As a result, it is possible to print with a favorable layout, such as the layouts shown in FIG. 15B.

In the procedure (A3), the width and height and position coordinates of an image data print region used for actually laying out an image to be printed on a print medium are set based on the sheet size obtained by the job information obtaining step (the step S301) in FIG. 4 and the layout pattern obtained by the procedure (A2) described above. This process is carried out by a database searching section 303 in FIG. 14 which outputs image data print region information. The width and height of the respective image data print regions are represented by numbers of pixels that can vary according to the resolution used to generate the print data. The image data print region information, that is, the width and height and position coordinates of the image data print region are obtained by searching a database using a combination of the sheet size and layout pattern. This database itself may be freely designed by a designer to set the layout used for printing. However, the layouts of images, ruled lines, and the like as print results of a first category (470, 474) and a second category (471, 475) shown in FIGS. 15A and 15B need to be symmetrical to each other so that they appear the same to the user. In the same way, the layouts of images, ruled lines, and the like as print results of both a third category (472, 476) and a fourth category (473, 477) shown in FIGS. 15A and 15B need to be symmetrical so as to appear the same to the user.

In the procedure (A4), the width and height and the position coordinates of the ruled lines 467 in FIG. 12B are set. This process is also carried out by the database searching section 303 appearing in FIG. 14, with ruled line information being outputted from the database searching section 303. The width and height of the ruled lines 467 are expressed as numbers of pixels according to the resolution used to generate the print data. Also, settings of the ruled line information, that is, the width, height, position coordinates, and colors of a ruled-line rectangle, can be made freely by the designer. Nevertheless, the layouts of images, ruled lines, and the like as print results of both the first category (470, 474) and the second category (471, 475) need to be symmetrical so as to appear the same to the user. In the same way, the layouts of images, ruled lines, and the like as print results of both the third category (472, 476) and the fourth category (473, 477) need to be symmetrical so as to appear the same to the user.

As should be clear from the above explanation and FIG. 14, if the inputted image file, the layout type, the sheet size, and the layout information for images and objects such as ruled lines required for generating the database searched by the database searching section 303 in FIG. 14 are obtained, it is possible to realize a favorable layout according to the above process.

The first example differs from the prior art in that viewing bottom orientation information of the inputted image is obtained and the viewing bottom orientation information is used to switch the layout pattern itself. This process in the present example can realize an extremely favorable layout for layout types where it is necessary to consider the up-down direction of images, such as that shown in FIG. 12B.

Also, although the first example has been described as having four layout patterns such as those shown in FIG. 15B and selectively using one such layout pattern as appropriate to carry out the layout printing shown in FIG. 12B, favorable layout results can also be obtained by providing two layout patterns, that is, the first category and the third category described above, for a single layout type, using the first category layout pattern for images classified into the first category and the second category, and using the third category layout pattern for images classified into the third category and the fourth category.

Although favorable layout printing can be realized when two layout patterns are provided or when four layout patterns are provided, there are also different advantages to each.

When two layout patterns are used, since there are only two types of layout information for a single layout type, the amount of memory used in storing the layout information is reduced. In addition, since it is not necessary to set respectively symmetrical layout patterns for the first and second categories and for the third and fourth categories, when “borderless” printing is carried out, the layout can be set easily without having to consider whether the images and objects are displaced due to differences in areas for off-the-edge print on the top, bottom, left, and right sides.

On the other hand, when there are at least four layout patterns corresponding to the orientations of image, a favorable layout car be realized without equipping a decoder, which is capable of rotating image files by 0° or 90° and then decoding the image files, with an additional function for rotating image files by 180° and 270°. Also, when the image data is laid out, a rotation process for images will be completely unnecessary if the inputted image data itself is in landscape orientation irrespective of the viewing bottom orientation, and therefore the processing load can be reduced.

It should be noted that regarding the reduction in the image rotating process, it is sufficient to have at least four patterns corresponding to orientations of images, and thus the present invention is not limited to having only four patterns.

In the prior art, when images are rotated and decoded, the desired data is obtained by first decoding all the image data, storing the entire decoded image in a memory, and then controlling the read order for the stored data. This method is extremely difficult to implement in systems having an embedded memory with limited memory capacity and therefore provided with a function that decodes only the actually required of image data at a time. To realize this function for decoding image data in part, it is necessary to frequently carry out file accesses to designate non-consecutive addresses, and to manage the position coordinates of pixels, and therefore the processing load is much larger than simple decoding. In particular, when handling, as inputted image data, a JPEG file which is divided into MCUs and the divided parts do not have a fixed bit length, before carrying out the partial decoding, it is necessary to view the entire file to grasp the boundaries between the divided parts of the image data, thereby obtaining the required position coordinate information.

In this regard, the process using the four layout patterns makes it unnecessary to rotate landscape image data, and is thus extremely effective for systems having a memory and a CPU with limited performance. Also, although it is still necessary to rotate and decode portrait images, since the majority of images that are picked up by a digital camera or the like are landscape images, the process can be said to be effective in most cases. However, in an environment such as a personal computer where there is more than enough memory so that an entire decoded image of one page can be stored, there is no merit to having four layout patterns. Rather, having two layout patterns that achieves the advantage mentioned earlier is superior.

Note that although the processing in the case where the print data is generated in single raster units so that the processing can be applied even to systems with limited memory capacity having been described in the first example, as should be obvious from the above explanation, the layout information generating process in the first example can also be carried out in a case where the print data is generated in units of two or more rasters.

As described above, in the first example, four or two layout patterns conforming to bottom orientations of images are provided for a single layout type, and an appropriate one of the layout patterns is selectively used according to the viewing bottom orientation information of the image and the lengthwise orientation of the image, and therefore it is possible to favorably carry out layout printing for an entire layout including objects such as ruled lines.

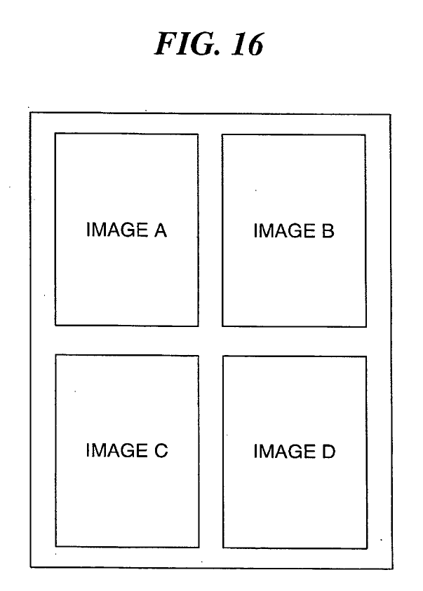

The second example of the present embodiment relates to the image laying out step (the step S305) in FIG. 4 described above, and in this example, image data are laid out as shown in FIG. 16. FIG. 16 is a diagram schematically showing an example of a single print medium on which a plurality of images are laid out. In the second example, the following construction and procedures are used to favorably lay out the plurality of image data A, B, C, and D according to the layout in FIG. 16.

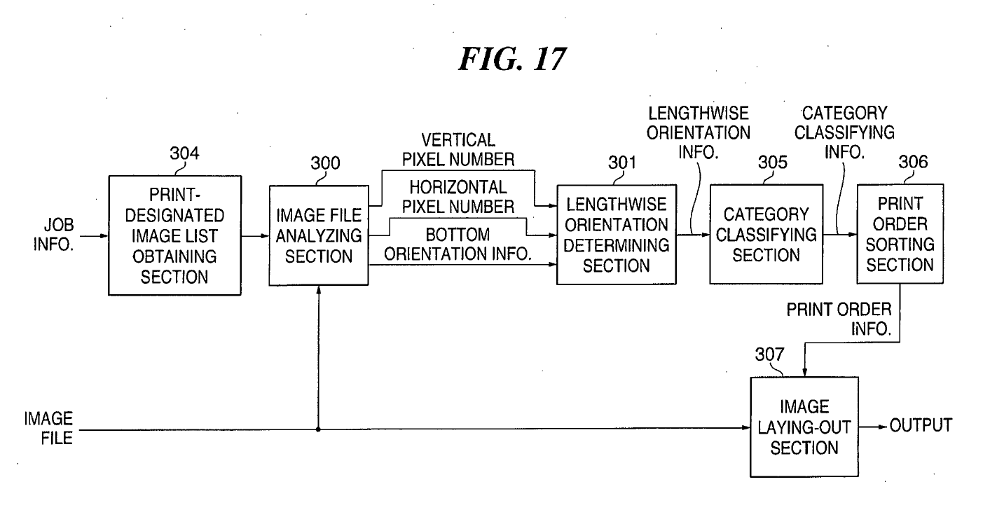

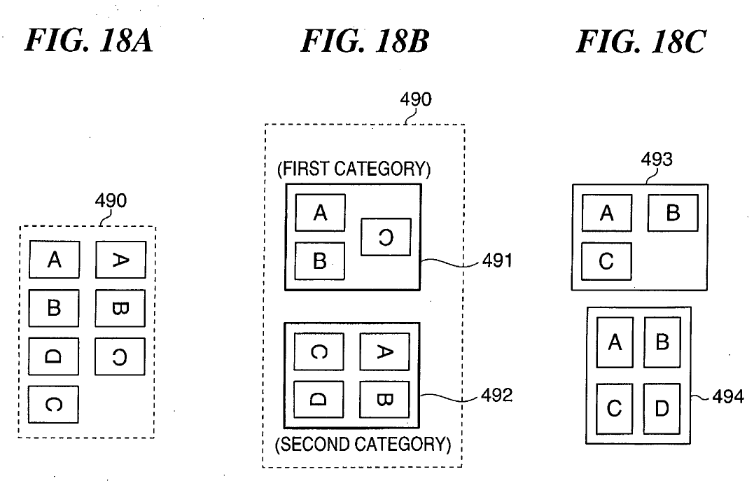

FIG. 17 is a block diagram showing a first module construction for realizing the image laying out step (the step S305) in the second example. FIGS. 18A, 18B, and 18C are diagrams useful in further explaining the second example. In this example, images are laid out by procedures (B1) to (B6) described below in the procedure (B1), a list 490 (see FIG. 18A) of a plurality of images designated for printing is obtained. This process is carried out by a print-designated image list obtaining section 304 in FIG. 17, with a print-designated image list being extracted from the job information set in advance.

In the procedure (B2), every image data file in the list 490 is analyzed to thereby obtain image sizes (numbers of vertical pixels and numbers of horizontal pixels) and viewing bottom orientation information. This process is carried out by an image file analyzing section 300 in FIG. 17, with the image sizes and viewing bottom orientation information being obtained in the same way as in the first example.

In the procedure (B3), the respective images in the list 490 are classified into two categories. This process is carried out by a lengthwise orientation determining section 301 and a category classifying section 305 in FIG. 17, and based on the image sizes and viewing bottom orientation information obtained in the procedure (B2) described above, it is determined whether each image data after being rotated so that its viewing bottom orientation coincides with a bottom edge of the image is in landscape orientation or portrait orientation. Then, the respective image data are classified into one of two categories (first and second categories).

This classifying process is carried out by the category classifying section 305, with the classifying into two categories being determined based on the combination of the lengthwise orientation of the image data obtained by the lengthwise orientation determining section 301 and the viewing bottom orientation information obtained by the procedure (B2) described above. For example, classifying is carried out according to the following method.

When the lengthwise orientation is the “up-down direction” and the viewing bottom orientation is “left or right”, the image data is classified into the first category, while when the lengthwise orientation is the “up-down direction” and the viewing bottom orientation is “top or bottom”, the image data is classified into the second category. Conversely, when the lengthwise orientation is the “left-right direction” and the viewing bottom orientation is “left or right”, the image data is classified into the second category, while when the lengthwise orientation is the “left-right direction” and the viewing bottom orientation is “top or bottom”, the image data is classified into the first category. Note that information on the lengthwise orientation can be obtained in the same way as in the processing in the first example.

In the procedure (B4), the print order of the plurality of images in the list 490 is sorted. This process is carried out by a print order sorting section 306 appearing in FIG. 17. In accordance with category classifying information obtained by the procedure (B3) described above, print order sorting is carried out such that a print order of first category classified images 491 (images classified as the first category) in FIG. 18B is sorted into a former half of the list 490, and a print order of second category classified images 492 (images classified as the second category) is sorted into a latter half of the list 490. Note that although the first category classified images are sorted into the former half, it should be obvious that the first category classified images may be sorted into the latter half instead.

In the procedure (B5), images to be laid out on each of one or more pages are determined. This process is carried out by an image laying-out section 307 appearing in FIG. 17. In some cases, a page break is inserted between the categories so as not to lay out the first category classified images 491 and the second category classified images 492 on the same page.

In the procedure (B6), these images are laid out on one or more pages (print medium or media). This process is also carried out by the image laying-out section 307. When laying out the whole or part of images on a print medium, it is determined which of the top, bottom, left, and right edges of the print medium is to be set as the bottom edge. Specifically, it is determined that the bottom edges of the images should coincide with the top, bottom, left, or right edge of the print medium (i.e., the print medium should be portrait-oriented or landscape-oriented at the time of printing). Next, the images are rotated and laid out in accordance with viewing bottom orientation information. Specifically, the image rotation/layout is performed such that the viewing bottom orientation information on the images coincides with the bottom edge of the portrait-oriented or landscape-oriented print medium. Here, a rotation angle used when laying out is set as image layout information, for the respective images laid out on the corresponding page without the image data being actually decoded, subjected to color space conversion, and the like. Such image layout information is subsequently referred to during the print data generating process.

Here, which of the top, bottom, left, and right edges of the print medium is to be set as the bottom edge is determined as follows: When the images to be laid out on the corresponding page have been rotated so that their viewing bottom orientations coincide with the bottom edge, if the image data after rotation are in portrait orientation, the top or bottom side of the print medium is selected as the bottom edge. When the image data are in landscape orientation, the left or right side of the print medium is selected. By doing so, even if the image data are rotated so that their viewing bottom orientations match with the bottom edge and with one another, it is possible to reduce the margin space produced on the print medium and print images as large as possible on the print medium.

Out of the procedures (B1) to (B6), the procedures (B1) to (B4) are carried out only at the start of a job and the procedures (B5) and (B6) are carried out at the start of each page.

As should be clear from the above description and FIG. 17, when the job information, the inputted image files, the layout type, and layout information relating to the image arrangement when actually laying out image files are obtained, it is possible to realize favorable layout printing according to the above process. That is, as shown by a print output 493 for the first category classified images 491 and a print output 494 for the first category classified images 492 appearing in FIG. 18C, it is possible to lay out and print a plurality of images extremely favorably with no mixing of portrait images and landscape images and with the viewing bottom orientations of the images matching with one another.

Conventionally, when a plurality of images are designated for printing and are printed with the layout shown in FIG. 16, the images are rotated and laid out so that the images are printed as large as possible on the print medium. For this reason, depending on the images, the viewing bottom orientations may not be uniform, thereby preventing favorable printing results from being obtained. On the other hand, in the second example, when a plurality of images are designated for printing, are laid out on a single print medium (using the layout shown in FIG. 16), and are printed, it is possible to realize favorable layout printing where the viewing bottom orientations match for all of the images as long as on the same page.

In addition, when all of the images on the same page are rotated so that the viewing bottom orientations are at the bottom, there is no mixing of portrait images and landscape images, and therefore little margin space is produced on the print medium even when images are rotated so that the viewing bottom orientations match, resulting in it being possible to print images as large as possible on the print medium in the same way as in the prior art.

The third example of the present embodiment relates to the image laying out step (the step S305) in FIG. 4. In the third embodiment, image data is laid out on a single print medium as shown in FIG. 16. To reduce the processing load when laying out a plurality of image data according to the layout shown in FIG. 16, the third example uses the construction and procedures described below.

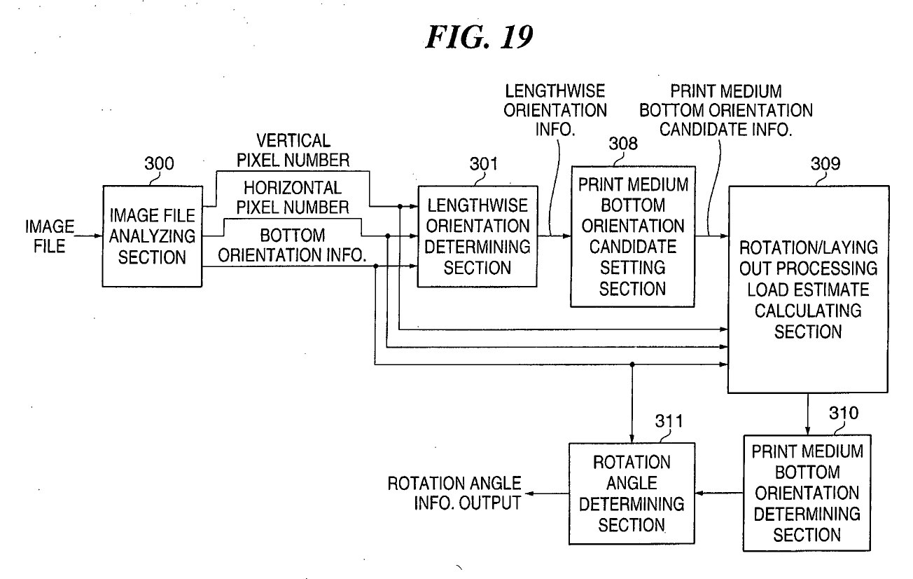

FIG. 19 is a block diagram showing a second module construction for realizing the image laying out step (the step S305) in the third example. Out of the procedures in the third example, only the procedure (B6) of the image laying out step differs to the procedures of the second example described above, with the other procedures (B1) to (B5) being the same. Procedures (B6-1) to (B6-4) of the image laying out step in the present example are carried out instead of the procedure (B6), and described below.

In the procedure (B6-1), candidates are given as to with which of the top, bottom, left, and right edges of the print medium the viewing bottom orientations of images are to be aligned. This process is carried out by a print medium bottom orientation candidate setting section 308 appearing in FIG. 19. When laying out images, it is determined which of the top, bottom, left, and right edges of the print medium is to be the bottom edge and images are laid out having been rotated in accordance with the viewing bottom orientation information. At this time, processing is carried out without actually decoding or carrying out a color-space conversion for the image data in the same way as in the procedure (B6) described earlier.

Here, the determination as to which of the top, bottom, left, and right edges of the print medium is to be set as the bottom edge is made as follows: If, when the images to be laid out on the corresponding page have been rotated so that the viewing bottom orientations coincide with the bottom edge, the image data after rotation are in portrait orientation, the top or the bottom of the print medium is set as a first candidate. Conversely if the image data after rotation are in landscape orientation, the left or the right of the print medium is set as a second candidate. By doing so, it is possible to reduce the margin space produced on a print medium even when images are rotated so that the viewing bottom orientations match with the bottom edge and with one another, and therefore it is possible to print images as large as possible on the print medium.

In the procedure (B6-2), estimates for a rotation/laying out processing load are calculated for the cases where the first and second candidates are respectively selected. This process is carried out by a rotation/laying out processing load estimate calculating section 309 appearing in FIG. 19. More specifically, a database is prepared so that estimated processing loads can be obtained from the file sizes of respective image data, the image sizes of respective image data, and a combination of rotation angles for all image data. Then, estimated processing loads for the cases where all of the images to be laid out on the corresponding page are rotated in accordance with the first candidate and in accordance with the second candidate are obtained, respectively. Here, the combination of rotation angles for all image data refers to a combination of rotation angles of image data other than one focus image data selected out of all the image data, wherein the combination or rotation angles of the other image data is determined for each of the cases where the image data in focus is laid out after being rotated by 0°, 90°, 180°, and 270°, respectively. In the present example, combinations of rotation angles are not outputted for a case where the lengthwise orientation of image layout frames on the print medium does not match with the lengthwise orientation of rotated image data to be laid out on the corresponding page (see procedure (B6-1)).

Finally, the estimated processing loads of all of the images to be laid out on the page for the case where the first candidate is selected are added to calculate the rotation/laying out estimated processing load for the entire page. Similarly, the rotation/laying out estimated processing load for the case where the second candidate is selected is also calculated.

In the procedure (B6-3), the candidate with the smaller rotation/laying out processing load is selected out of the two candidates. This process is carried out by a print medium bottom orientation determining section 310 in FIG. 19. The estimated processing loads obtained in the procedure (B6-2) are compared for the respective candidates and the candidate with the smaller estimated processing load is selected.

In the procedure (B6-4), rotation angles for laying out are set for the respective images on the page. This process is carried out by a rotation angle determining section 311 appearing in FIG. 19. A rotation angle for laying out with the print medium in the orientation selected in the procedure (B6-3) described above is set separately for every image on the page.

As should be clear from the above description and FIG. 19, when the job information, the inputted image files, the layout type, the layout information relating to the image arrangement when actually laying out image files, the image file sizes required to calculate estimated loads for the rotation/laying out process, the image sizes, and the database in which estimated processing loads can be found from combinations of rotation angles are obtained, it is possible to realize favorable layout printing according to the above process.

As described above, in the second example, when printing a plurality of pages where a plurality of images are laid out on a single print medium, it is possible to realize favorable layout printing where the viewing bottom orientations of all images on the same page match with one another. There is additionally the effect that small margins are generated on the print medium when the images are rotated to make the viewing bottom orientations match, and therefore the images can be printed as large as possible on the print medium as in the prior art. In the third example, candidates that indicate which of the top, bottom, left, and right edges of the print medium is matched with the viewing bottom orientations of the images are proposed, a combination where the smallest processing load of a process that obtains images after rotation on the page concerned is found from the candidates, and then images are rotated accordingly, so that in addition to the effects of the second example described above, it is possible to reduce the processing during laying out.

Also, the second and third examples can provide a layout where images are favorably laid out regardless of which of the top, bottom, left, and right edges of the print medium is set as the bottom edge so long as the lengthwise orientations and the viewing bottom orientations of the image data A, B, C, and D laid out on the page are all equal as shown in FIG. 16. However, as shown in FIGS. 12A and 12B, when objects aside from images, such as ruled lines, are present, if used without amendment, the second and third examples have no effect for layout types where it is also necessary to make the up-down directions of the objects equal to one another. In this case, a favorable layout can be realized by combining the second or third examples with the first example.

To do so, first, before the layout information generating step (the step S304) in FIG. 4 and before entering a page loop, the procedures (B1) to (B4) of the image laying out step (the step S305) described above for the second and third examples are carried out. Since these processes are fundamentally carried out only at the start of a job, there are no adverse effects from carrying out such processes in such timing.

Next, the procedure (B5) of the image laying out step (the step S305) is carried out before the layout information generating step (the step S304) in FIG. 4 but after entering the page loop. Since according to this process, images that are in portrait orientation and images that are in landscape orientation after the images designated for printing have been aligned according to the viewing bottom orientations are not laid out on the same page, it is possible to apply the first example, with it also being possible to achieve a favorable print output for layout types where the up-down orientations have to be made uniform for images and also for objects.

In this case, the layout information generating process (the step S304) in FIG. 4 has the same role as in the first example, and therefore the image laying out step (the step S305) in FIG. 4 carries out only the procedure (B6)

The fourth example of the present embodiment relates to the image laying out step (the step S305) in FIG. 4 and lays out image data as shown in FIG. 16. To easily and favorably lay out a plurality of image data according to the layout shown in FIG. 16, the fourth example uses the following construction and procedures.

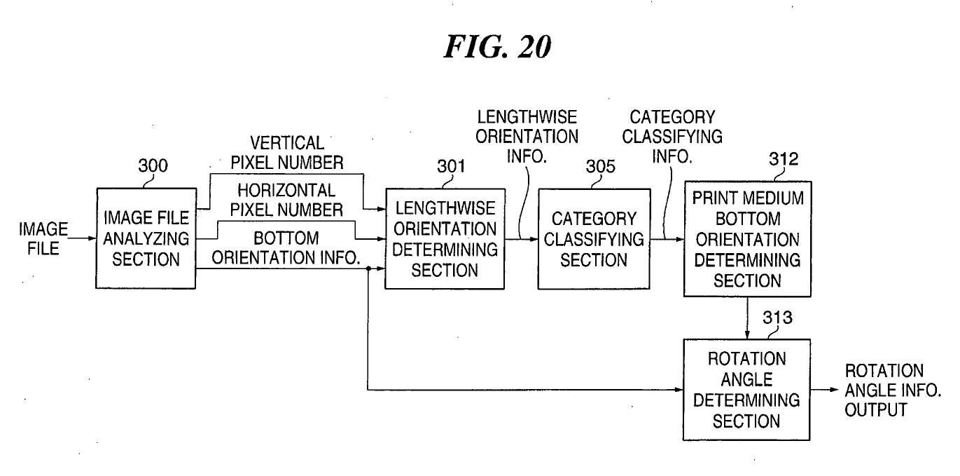

FIG. 20 is a block diagram showing a third module construction for realizing the image laying out step (the step S305) in the fourth example. Procedures (C1) to (C3) of the image laying out step (the step S305) according to the present example will now be described.

In the procedure (C1), all image data files to be laid out on the page concerned are analyzed to obtain the image sizes (numbers of vertical pixels and numbers of horizontal pixels) and viewing bottom orientation information. This process is carried out by an image file analyzing section 300 appearing in FIG. 20, with the image sizes and the viewing bottom orientation information being obtained in the same way as in the first example.

In the procedure (C2), the images in the list are classified into two categories. This process is carried out by a lengthwise orientation determining section 301 and a category classifying section 305 appearing in FIG. 20. That is, based on the image sizes and the viewing bottom orientation information obtained in the procedure (C1) described above, it is determined whether images are in portrait orientation or landscape orientation after the image data has been rotated, if necessary, to coincide the viewing bottom orientations with the bottom edge, and the images are classified into two categories (the first category and the second category).

In the procedure (C3), the images are laid out on the page. This process is carried out by a print medium bottom orientation determining section 312 and a rotation angle determining section 313 appearing in FIG. 20. When laying out images, which of the top, bottom, left, and right edges of the print medium is to be set as the bottom edge is determined and the images are laid out after being rotated in accordance with the viewing bottom orientation information. At this time, in the same way as in the procedure (B6) described earlier, processing is carried out without actually decoding the image data or converting the color space.

Here, which of the top, bottom, left, and right edges of the print medium is to be set as the bottom edge is determined as follows: First, an up-down (portrait) orientation or a left-right (landscape) orientation of the print medium is selected as a candidate according to which of such orientations has a larger number of print rectangular regions which are provided for respective images on the print medium and which have longitudinal directions that match longitudinal directions of the images to be laid out on the page after rotation when such images are rotated so that the viewing bottom orientations thereof are at the bottom edge. There are no particular limitations on the selection method used here, which may be freely determined by the designer. This selection process is carried out by the print medium bottom orientation determining section 312. After this, the rotation angles for laying out the respective images are set so that the viewing bottom orientation of every image laid out on the present page matches the determined bottom orientation of the print medium. This setting is carried out by the rotation angle determining section 313. By doing so, the viewing bottom orientation of every image can be easily matched with the bottom orientation of the print medium.

As should be clear from the above description and FIG. 20, if the print-designated image information, the inputted image files, and the layout information relating to the image arrangement used when actually laying out the image files are obtained, it is possible to realize favorable layout printing according to the above process.

In the fourth example, when printing with the layout shown in FIG. 16, that is, when a plurality of images are designated for printing and a plurality of pages are printed with a plurality of images laid out on a single print medium, it is possible to easily make the viewing bottom orientations of every image on the same page match the bottom orientation of the print medium, and therefore favorable layout printing can be easily realized.

Note that although the second, third, and fourth examples have been described with the premise of processing that generates print data in single raster units and can therefore be applied in systems having a memory with limited capacity, as can be easily understood from the above description, the processing in the layout information generating step (the step S304), the internal character string laying out step (the step S308), and the image data zooming step (the steps S504, S543, and S553) is obviously not dependent on the units in which the print data is generated.

Although, an embodiment of the present invention and several examples thereof have been described, it should be obvious that the effect of the present invention can be obtained not only when the entire image region is obtained as inputted image data by simply decoding image files but also when data for an image region designated for trimming by a digital camera or the like is handled as the inputted image data. In this case, it should be obvious that the image size obtainment and the lengthwise orientation determination for the image data should be carried out after the trimming.

It should also be obvious that the image recording apparatus according to the present invention may be any apparatus that receives image data from a host apparatus or various kinds of memories, and is not limited to a directly connectable photo printer.

In addition, although a system where a host apparatus and an image recording apparatus are connected and a system where the memory card is directly connected to an image recording apparatus have been described in the above embodiment, it should be obvious that the present invention can be applied to other systems constructed of a plurality of appliances where image data is inputted into an image recording apparatus and print data produced by laying out such image data is generated.

It is to be understood that the present invention may also be accomplished by supplying a system or an apparatus with a storage medium in which a program code of software which realizes the functions of the above described embodiment is stored, and causing a computer (or CPU or MPU) of the system or apparatus to read out and execute the program code stored in the storage medium.

In this case, the program code itself read out from the storage medium realizes the functions of the embodiment described above, and hence the program code and the storage medium in which the program code is stored constitute the present invention.

Examples of the storage medium for supplying the program code include a floppy (registered trademark) disk, a hard disk, a magneto-optical disk, an optical disc such as a CD-ROM, a CD-R, a CD-RW, a DVD-ROM, a DVD-RAM, a DVD−RW, and a DVD+RW, a magnetic tape, a nonvolatile memory card, and a ROM. Alternatively, the program code may be supplied by downloading via a network.

Further, it is to be understood that the functions of the above described embodiment may be accomplished not only by executing a program code read out by a computer, but also by causing an OS (operating system) or the like which operates on the computer to perform a part or all of the actual operations based on instructions of the program code.

Further, it is to be understood that the functions of the above described embodiment may be accomplished by writing a program code read out from the medium, such as a storage medium, into a memory provided on an expansion board inserted into a computer or in an expansion unit connected to the computer and then causing a CPU or the like provided in the expansion board or the expansion unit to perform a part or all of the actual operations based on instructions of the program code.

### CROSS REFERENCE TO RELATED APPLICATION

This application claims priority from Japanese Patent Application No. 2004-358970 filed Dec. 10, 2004, which is hereby incorporated by reference herein.

What is claimed is:

1. An image recording apparatus comprising:
a rotation information obtaining device that obtains rotation information of image data;
a layout switching device that selects a print layout in accordance with the rotation information; and
a print data generating device that generates, in accordance with the print layout selected by said layout switching device, print data for printing a print medium on which the image data is laid out.

2. An image recording apparatus according to claim 1, wherein said layout switching device includes at least four layout patterns for each of at least one layout type, and selects a predetermined layout pattern according to the rotation information, out of the four layout patterns.

3. An image recording apparatus according to claim 1, wherein said layout switching device includes two layout patterns for each of the at least one layout type, and selects one of the two layout patterns according to a result of a determination to determine whether the image data is for a landscape image or a portrait image based on a viewing bottom orientation included in the rotation information.

4. An image recording apparatus comprising:
a rotation information obtaining device that obtains respective rotation information of a plurality of image data;
a sorting device that sorts a print order of the plurality of image data in accordance with the respective rotation information; and
a print data generating device that generates, in accordance with the print order sorted by said sorting device, print data for printing a print medium on which at least one image data out of the plurality of print data is laid out.

5. An image recording apparatus according to claim 4, wherein said sorting device comprises:
an image size obtaining device that obtains image sizes of the plurality of image data; and
an image data lengthwise orientation determining device that determines whether the plurality of image data having been rotated so that bottom orientations thereof are set at a bottom edge of the print medium are each in portrait orientation or landscape orientation, based on the image sizes obtained by said image size obtaining device and the rotation information, and
wherein said sorting device sorts the print order of the plurality of image data based on a determination result obtained by said image data lengthwise orientation determining device.

6. An image recording apparatus according to claim 5, comprising a layouter that lays out the plurality of image data on at least one print medium, and
wherein said layouter lays out the plurality of image data on the at least one print medium such that image data determined to be in portrait orientation by said image data lengthwise orientation determining device and image data determined to be in landscape orientation are not laid out on a same print medium.

7. An image recording apparatus according to claim 6, wherein said layouter includes a bottom orientation uniforming device that rotates the plurality of image data in accordance with the rotation information so that bottom orientations of image data laid out on a same print medium are made equal to one another.

8. An image recording apparatus according to claim 7, comprising a memory with a limitation of being incapable of storing an entire decoding result obtained when the plurality of image data are decoded, and
wherein said bottom orientation uniforming device comprises:
a combination detecting device that detects a combination of the respective rotation information of the plurality of image data that minimizes a processing load of a process to be carried out by said bottom orientation uniforming device to obtain the plurality of image data having been rotated; and
an image rotating section that rotates the image data in accordance with the combination detected by said combination detecting device.

9. An image recording apparatus according to claim 6, wherein said layouter includes two layout patterns for each of at least one layout type, and uses one of the two layout patterns according to whether the image data to be laid out on a same page corresponding to the print medium is in landscape orientation or portrait orientation.

10. An image recording apparatus comprising:
a rotation information obtaining device that obtains respective rotation information of a plurality of image data;
a rotation angle determining device that determines rotation angles for the plurality of image data when the plurality of image data are laid out, in accordance with the rotation information; and
a print data generating device that generates, in accordance with the rotation angles determined by said rotation angle deciding device, print data for printing a print medium on which the image data are laid out.

11. An image recording apparatus according to claim 10, wherein said rotation angle determining device includes a focus orientation determining device that determines which out of top, bottom, left, and right edges of the print medium is a focus orientation edge, and determines the rotation angles of the image data based on the rotation information so that the focus orientation edge determined by said focus orientation determining device matches with bottom orientations of the image data.

12. An image recording apparatus according to claim 11, wherein the focus orientation edge is uniquely determined for a layout pattern for laying out the image data on the print medium.

13. An image recording apparatus according to claim 11, wherein the focus orientation edge is determined such that those images are increased in number which correspond to the image data and whose lengthwise orientations determined with reference to viewing bottom orientations of the images determined from the rotation information match with lengthwise orientations of image layout frames determined according to a layout pattern for laying out the image data on the print medium.

14. An image recording apparatus comprising:
a rotation information obtaining device that obtains rotation information of image data;
a layout device that sets a layout for laying out the image data, with the layout reflecting the rotation information; and
a print data generating device that generates, in accordance with the layout set by said layout device, print data for printing a print medium on which the image data is laid out.

15. A print data generating method for an image recording apparatus, comprising:
a rotation information obtaining step of obtaining rotation information of image data;
a layout switching step of selecting a print layout in accordance with the rotation information; and
a print data generating step of generating, in accordance with the print layout selected in said layout switching step, print data for printing a print medium on which the image data is laid out.

16. A print data generating method for an image recording apparatus, comprising:
a rotation information obtaining step of obtaining respective rotation information of a plurality of image data;
a sorting step of sorting a print order of the plurality of image data in accordance with the respective rotation information; and
a print data generating step of generating, in accordance with the print order sorted in said sorting step, print data for printing a print medium on which at least one image data out of the plurality of print data is laid out.

17. A print data generating method for an image recording apparatus, comprising:
a rotation information obtaining step of obtaining respective rotation information of a plurality of image data;
a rotation angle determining step of determining rotation angles for the plurality of image data when the plurality of image data are laid out, in accordance with the rotation information; and
a print data generating step of generating, in accordance with the rotation angles determined in said rotation angle determining step, print data for printing a print medium on which the image data are laid out.

18. A print data generating method for an image recording apparatus, comprising:
a rotation information obtaining step of obtaining rotation information of image data;
a layout step of setting a layout for laying out the image data, with the layout reflecting the rotation information; and
a print data generating step of generating, in accordance with the layout set in said layout step, print data for printing a print medium on which the image data is laid out.

19. A computer-readable control program for causing a computer to implement a print data generating method for an image recording apparatus, the control program comprising:
a rotation information obtaining module for obtaining rotation information of image data;
a layout switching module for selecting a print layout in accordance with the rotation information; and
a print data generating module for generating, in accordance with the print layout selected by said layout switching module, print data for printing a print medium on which the image data is laid out.

20. A computer-readable control program for causing a computer to implement a print data generating method for an image recording apparatus, the control program comprising:
a rotation information obtaining module for obtaining respective rotation information of a plurality of image data;
a sorting module for sorting a print order of the plurality of image data in accordance with the respective rotation information; and
a print data generating module for generating, in accordance with the print order sorted by said sorting module, print data for printing a print medium on which at least one image data out of the plurality of print data is laid out.

21. A computer-readable control program for causing a computer to implement a print data generating method for an image recording apparatus, the control program comprising:
a rotation information obtaining module for obtaining respective rotation information of a plurality of image data;
a rotation angle determining module for determining rotation angles for the plurality of image data when the plurality of image data are laid out, in accordance with the rotation information; and
a print data generating module for generating, in accordance with the rotation angles determined by said rotation angle determining module, print data for printing a print medium on which the image data are laid out.

22. A computer-readable control program for causing a computer to implement a print data generating method for an image recording apparatus, the control program comprising:
a rotation information obtaining module for obtaining rotation information of image data;
a layout module for setting a layout for laying out the image data, with the layout reflecting the rotation information; and
a print data generating module for generating, in accordance with the layout set by said layout module, print data for printing a print medium on which the image data is laid out.
